(19) United States
(12) Patent Application Publication
(10) Pub. No.: US 2012/0203711 A1
(43) Pub. Date: Aug. 9, 2012

(54) SYSTEM AND METHOD OF MANAGING AN INVESTMENT ON BEHALF OF AN INVESTOR

(75) Inventors: Adrian Gore, Sandton (ZA); Kenneth Steven Rabson, Johannesburg (ZA); Herschel Phillip Mayers, Johannesburg (ZA)

(73) Assignee: DISCOVERY HOLDINGS LIMITED, Sandton (ZA)

(21) Appl. No.: 13/365,527

(22) Filed: Feb. 3, 2012

(30) Foreign Application Priority Data
Feb. 4, 2011 (ZA) 2011/00937

(51) Int. Cl. G06Q 40/06

(52) U.S. Cl. 705/36 R

(57) ABSTRACT

A method and system for managing an investment on behalf of an investor includes a monitoring module to monitor the performance of an investment over a period of time, the investment being an investment managed by an investment manager on behalf of an investor. A comparator module compares the performance of the investment with the performance of other similar types of investments for the period of time and a fee performance module determines a fee refund payment to the investor in the event that the performance of the investment in the period of time falls by a predetermined level below similar funds ranked by performance. A payments module effects the extra payment from the investment manager to the investor.

### BACKGROUND OF THE INVENTION

The present invention relates to a system and method of managing an investment on behalf of an investor.

An investor often chooses an investment manager to invest funds on their behalf. In this scenario, the investor normally gives the investment manager guidelines on what type of asset class or type of fund in which they wish to invest but then relies on the investment manager to select a particular investment within that asset class or type of fund.

For their services, the investor typically pays a fee to the investment manager, which fee is non-refundable.

To implement a performance-based fee is not simple as the fee would be determined on the performance of the fund in a predetermined historical period. In a case where the fund used to be performing well but is now performing not as well this type of fee structure prejudices new entrants into the fund with a need to pay higher fees based on past performance for which they have not enjoyed the benefit.

The present invention seeks to address this.

### SUMMARY OF THE INVENTION

According to one example embodiment there is provided a system for managing an investment on behalf of an investor, the system including:
a monitoring module to monitor the performance of an investment over a period of time, the investment being an investment managed by an investment manager on behalf of an investor;
a comparator module to compare the performance of the investment with the performance of other similar types of investments for the period of time
a fee performance module to determine a fee refund payment to the investor in the event that the performance of the investment in the period of time falls by a predetermined level below similar funds ranked by performance; and
a payments module to effect the extra payment from the investment manager to the investor.

In one embodiment, the fee performance module determine the fee refund payment to the investor in the event that the performance of the investment in the period of time falls below the top 25% of similar funds ranked by performance.

According to another example embodiment there is provided a method for managing an investment on behalf of an investor, the method including:
monitoring the performance of an investment over a period of time, the investment being an investment managed by an investment manager on behalf of an investor;
comparing the performance of the investment over the period of time with the performance of other similar types of investments for the period of time;
determining a fee refund payment to the investor in the event that the performance of the investment in the period of time falls by a predetermined level below similar funds ranked by performance; and
paying the extra payment from the investment manager to the investor.

### BRIEF DESCRIPTION OF THE DRAWINGS

FIG. 1 is a block diagram illustrating an example system to implement the methodologies described herein; and

FIG. 2 is a block diagram illustrating an example embodiment method.

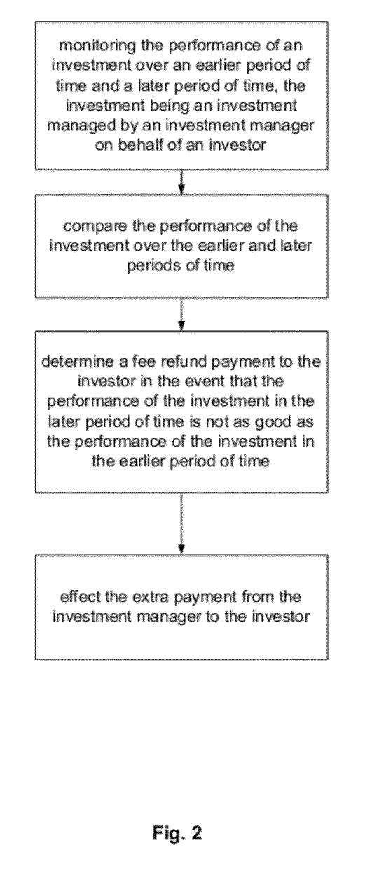

### DESCRIPTION OF EMBODIMENTS

The present invention relates to a system and method of managing an investment on behalf of an investor.

An investor often chooses an investment manager to invest funds on their behalf. In this scenario, the investor normally gives the investment manager guidelines on what type of asset class or type of fund in which they wish to invest but then relies on the investment manager to select a particular investment within that asset class or type of fund.

The investment manager typically sets their fee based on the past performance of a particular investment. The performance in the period of the investment might be significantly lower compared to the past period which was used to calculate the performance fee.

If the investment manager does not select the best performing fund and performance compared relative to similar investments is worse than in the past period the investor obviously loses out.

A system and method for addressing this is described below.

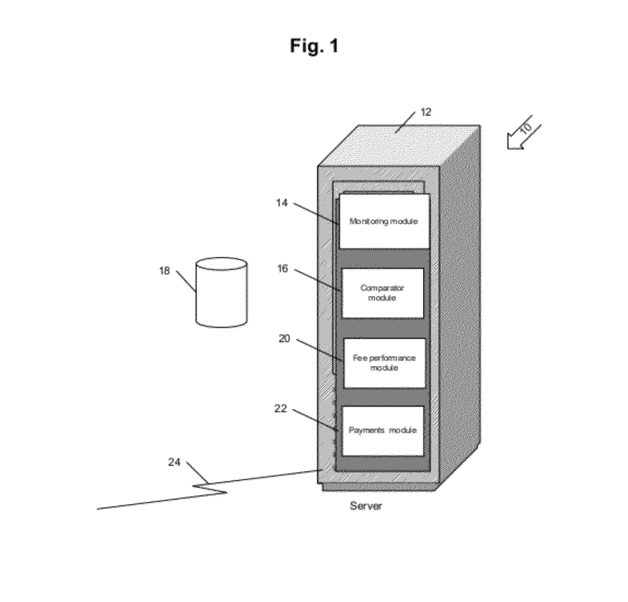

Referring to FIG. 1, an information processing system 10 may include a server 12 that includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 12 includes a monitoring module 14 that monitors the performance of an investment over a period of time, the investment being an investment managed by an investment manager on behalf of an investor.

It will be appreciated that the investment could be any type of investment such as cash, bonds, stocks, property or an investment fund to name but a few examples.

For purposes of illustration, the present invention will be described with reference to the use of an investment fund.

In any event, the monitoring module 14 typically receives investment data via communications network 24 typically from a third party data provider. The network, in one embodiment, is a wide area network, local area network, wireless network, or the like. The investment data at least includes such information as unit prices, fees paid and income generated by the investment.

The investment data is stored in the memory 18 for use by a comparator module 16.

The comparator module 16 compares the performance of the investment over the of time with the performance of other similar types of investments for the period of time. This will be described in more detail below.

A fee performance module 20 determines a fee refund payment to the investor in the event that the relative performance of the investment in the period of time falls below the top 25% of similar funds ranked by performance over the period.

A payments module 22 effects the extra payment to the investor. This payment may be made from the investment manager or from a third party.

The system and method implemented by the system is aimed at ensuring that performance fees can be charged by an investment manager without prejudicing a person that has joined the fund at a time when the fund is not performing as well as the fund has historically performed.

An example method that will be implemented by the system is described as follows.

In the illustrated embodiment, the fee refund is calculated as a percentage fee refund being a percentage of the fee paid.

Fee Refund % for Fund(i) at t=[TER−Average Fee in Sector of Fund(i)]*Discount %*Average number of units in Fund(i) during last year*Unit Price Fund(i) at t

where
TER=Total Asset Manager Expense Ratio for Fund(i) (this measure includes performance fees)
Avge Fee in sector=Average fee for a similar fund in the same sector as Fund(i)

The average number of units in a specific fund during the last year is equal to the number of units at the start proportionally increased/decreased allowing for switches into or withdrawals from the fund. There will be no refund on a fund where the client does a 100% withdrawal before the end of the year.

Discount%=Depends on performance of Fund(i) over the last year (See table below)

| Rank in sector | Discount % |
|---|---|
| 1^{st} Quartile | 0% |
| 2^{nd} Quartile | 33% |
| 3^{rd} Quartile | 66% |
| 4^{th} Quartile | 100% |

The abovementioned sector rank is determined as described below.

For example consider an investment in a fund that had good historic performance and hence has a total fee of 3.5% pa compared to the market average of 1.5% pa. Each year the performance of the investment will be compared to the performance of similar investment funds and the performance ranked from best to worst. If the performance of the investment is for example in the bottom 25% of funds then 100% of the excess fee charged of 2% pa (i.e. 3.5%−1.5%=2%) will be calculated and be eligible to be refunded to the investor. The average refund will then be calculated as 2% of the average value of the fund during the period.

Firstly, it will be appreciated that sector classification could be done in a number of ways. One example is for the investment manager to predefine the sector classification in an obvious manner. For example, a unit trust that invests solely in equities could be predefined to be compared with other unit trusts that invest solely in equities.

Another method of determining the sector classification is to use an industry standard. An example in South Africa is the industry body ASISA classification of sectors.

When comparing the performance of the various funds it will also be appreciated that different methodologies could be used. The most basic methodology is simply to compare the value of the fund over the period of time. However, at the methodologies could also be used including determining the income generated by the investment over the period of time. In the case of equities, this would entail comparing the dividends distributed for example.

In the example embodiment the comparator module 16 compares the performance of the fund with the selected other funds and determines in which quartile the performance of the fund falls.

It will be appreciated that this comparison could be done in other ways not using quartiles but rather using other percentages or ranking systems.

It will also be appreciated that the percentages listed above in the table are exemplary and could be altered as required.

Thus it will be appreciated that a new set of fair performance fee funds will be introduced ensuring that for certain funds, investors will receive a refund based on the performance fees they may have paid on these funds relative to average fees for similar funds in the sector.

In one example, the refund will accumulate annually but will only pay out every 5 years (with no interest). The size of the refund will be the biggest on those funds with the worst performance in their respective fund sector.

In one example, a fee will be charged to provide this benefit,

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

Although the various embodiments of the present invention are described in the context of a fully functional computer system, those skilled in the art will appreciate that embodiments are capable of being distributed as a program product via CD or DVD, e.g. CD, CD ROM, or other form of recordable media.

What is claimed is:

1. A computer system for managing an investment on behalf of an investor, the system including:
a monitoring module to monitor the performance of an investment over a period of time, the investment being an investment managed by an investment manager on behalf of an investor;
a comparator module to compare the performance of the investment with the performance of other similar types of investments for the period of time
a fee performance module to determine a fee refund payment to the investor in the event that the performance of the investment in the period of time falls by a predetermined level below similar funds ranked by performance; and
a payments module to effect the extra payment from the investment manager to the investor.

2. A computer system according to claim 1 wherein the fee performance module determines the fee refund payment to the investor in the event that the performance of the investment in the period of time falls below the top 25% of similar funds ranked by performance.

3. A computer system according to claim 1 wherein the monitoring module receives investment data via a communications network.

4. A computer system according to claim 3 wherein the monitoring module receives the investment data from a third party data provider.

5. A computer system according to claim 1 wherein the investment data includes at least some of information as unit prices, fees paid and income generated by the investment.

6. A computer system according to claim 1 wherein the fee performance module determines the fee refund payment to the investor based on the following formula:
Fee Refund % for Fund(i) at t=[TER−Average Fee in Sector of Fund(i)]*Discount %*Average number of units in Fund(i) during last year*Unit Price Fund(i) at t
where
TER=Total Asset Manager Expense Ratio for Fund(i);
Avge Fee in sector=Average fee for a similar fund in the same sector as Fund(i);
the average number of units in a specific fund during the last year is equal to the number of units at the start proportionally increased/decreased allowing for switches into or withdrawals from the fund; and
Discount %=Depends on performance of Fund(i) over the last year.

7. A computer system according to claim 1 wherein the fee performance module determines the discount percentage using the following table:

| Rank in sector | Discount % |
|---|---|
| 1^{st} Quartile | 0% |
| 2^{nd} Quartile | 33% |
| 3^{rd} Quartile | 66% |
| 4^{th} Quartile | 100% |

8. A method for managing an investment on behalf of an investor, the method including:
Monitoring, by a computer, the performance of an investment over a period of time, the investment being an investment managed by an investment manager on behalf of an investor;
Comparing, by the computer, the performance of the investment over the period of time with the performance of other similar types of investments for the period of time;
Determining, by the computer, a fee refund payment to the investor in the event that the performance of the investment in the period of time falls by a predetermined level below similar funds ranked by performance; and
Paying the extra payment from the investment manager to the investor.

9. A method according to claim 8 wherein the investment data is received via a communications network.

10. A method according to claim 9 wherein the investment data is received from a third party data provider.

11. A method according to claim 8 wherein the investment data includes at least some of information as unit prices, fees paid and income generated by the investment.

12. A method according to claim 8 wherein the fee refund payment to the investor is determined based on the following formula:
Fee Refund % for Fund(i) at t=[TER−Average Fee in Sector of Fund(i)]*Discount %*Average number of units in Fund(i) during last year*Unit Price Fund(i) at t
where
TER=Total Asset Manager Expense Ratio for Fund(i);
Avge Fee in sector=Average fee for a similar fund in the same sector as Fund(i);
the average number of units in a specific fund during the last year is equal to the number of units at the start proportionally increased/decreased allowing for switches into or withdrawals from the fund; and
Discount %=Depends on performance of Fund(i) over the last year.

13. A method according to claim 8 wherein the discount percentage is determined using the following table:

| Rank in sector | Discount % |
|---|---|
| 1^{st} Quartile | 0% |
| 2^{nd} Quartile | 33% |
| 3^{rd} Quartile | 66% |
| 4^{th} Quartile | 100% |
